(19) United States
(12) Patent Application Publication
(10) Pub. No.: US 2022/0153610 A1
(43) Pub. Date: May 19, 2022

(54) Method for Degassing Water and Gas Balancing Filter

(71) Applicant: Alpha Aqua A/S, Esbjerg (DK)

(72) Inventor: Ramon PEREZ, Esbjerg (DK)

(21) Appl. No.: 17/587,021

(22) Filed: Jan. 28, 2022

Related U.S. Application Data
(63) Continuation of application No. PCT/DK2020/000230, filed on Jul. 23, 2020.

(30) Foreign Application Priority Data
Jul. 31, 2019 (DK) PA 2019 00914

(51) Int. Cl. C02F 1/20; B01D 19/00; A01K 63/04

(52) U.S. Cl. CPC C02F 1/20; C02F 2103/20; A01K 63/045; B01D 19/0042

(57) ABSTRACT

A method for degassing carbon dioxide from a stream of water is provided, whereby water is supplied at a predefined volumetric flow to a gas balancing filter, wherein the water in a first step is collected in a basin with a free upper surface and a depth and in a second step is allowed to flow out of the basin through at least one orifice provided beneath the free upper surface and in a third step the water flowing out of the orifice is allowed to free-fall a distance D through a controlled atmosphere and is then collected in a further basin provided beneath the basin. The invention comprises the further steps that the first, second and third steps are repeated two or more times with basins provided consecutively below each other. A gas balancing filter is also provided.

### CROSS REFERENCE TO RELATED APPLICATIONS

This application is a continuation under 35 U.S.C. 111 of International Patent Application No. PCT/DK2020/000230, filed Jul. 23, 2020, which claims the benefit of and priority to Danish Application No. PA 2019 00914, filed Jul. 31, 2019, each of which is hereby incorporated by reference in its entirety.

### FIELD OF INVENTION

The present invention relates to a method for degassing carbon dioxide (CO₂) from water. The invention also relates to a gas balancing filter.

### BACKGROUND

It is known to supply water with a predefined volumetric flow to a gas balancing filter, wherein the water in a first step is collected in a basin with a free upper surface and a depth and in a second step is allowed to flow out of the basin through at least one orifice provided beneath the free upper surface and in a third step the water flowing out of the orifice is allowed to free-fall a distance D through a controlled atmosphere and is then collected in a further basin provided beneath the basin. The collected water will contain some carbon dioxide as diffusion of carbon dioxide out of the water will be most efficient in parts of the water leaving the orifices, which are closest to a surface of a trickle-down water column leaving the orifice. Also, any carbon dioxide bound in the water, as carbonic acid, will not have sufficient time to convert to dissolved CO₂ in the water.

EP 3342284 describes a device for aeration of and separation of carbon dioxide from a fluid, such as water from a fish tank. The device comprises a plurality of screen gears (i.e. plates with orifices), placed perpendicularly, or essentially perpendicularly, to the direction of the flow of fluid that hits and passes them. The screen gears (101) are preferably separated from each other by a distance of 10-250 mm. A fan may be used to remove separated carbon dioxide from the device. Preferably about 60% of the screen gear is covered by fluid at operation.

U.S. Pat. No. 4,427,548 describes a method and an apparatus for filtering and detoxifying aquarium water and wastewater streams, e.g. by removing carbon dioxide. The method comprises flowing water from the aquarium downwardly in a single or multi-layer trickle water filter comprised of at least one top filter tray and preferably one or more lower filter trays located beneath said upper tray and supporting it in a manner such that the trays are stacked one atop another, through non-submerged, porous, open-cell material whose non-submerged part is exposed to the air or other mixture containing gaseous oxygen. Water is distributed evenly across the top of the layer of porous material. The top of said filter material is exposed to natural or artificial oxygenated atmosphere so that the water trickled into the top of the upper filter tray is at least partially aerated. The invention accomplishes the removal of excess carbon dioxide from water containing such excess carbon dioxide. The apparatus comprises a reservoir under the last filter tray, which collects the water, which is then returned to the aquarium.

KR 20110111126 describes an apparatus for degassing of water and carbon dioxide removal from an aquatic culture, comprising two or more horizontal plates having a plurality of through holes, a water inlet, a carbon dioxide outlet, an air blower, an air inlet and water outlet.

The prior art does not mention the use of a residence time for the water to be aerated whereby the residence time is provided prior to each trickle-down event, such as at two, three or more individual trickle-down events.

Thus, there is a need for a method and an apparatus which enables a more efficient degassing of the water and which reduces or even eliminates the above-mentioned disadvantages of the prior art. An alternative to prior art ways of degassing water used in Recirculated Aquatic Systems (RAS) is desired.

### BRIEF DESCRIPTION

A method for degassing carbon dioxide from a stream of water is provided, whereby water is supplied at a predefined volumetric flow to a gas balancing filter, wherein the water in a first step is collected in a basin with a free upper surface and a depth and in a second step is allowed to flow out of the basin through at least one orifice provided beneath the free upper surface and in a third step the water flowing out of the at least one orifice is allowed to free-fall a distance D through a controlled atmosphere and is then collected in a further basin provided beneath the basin. The predefined volumetric flow of the water is selected, the orifices are numbered and dimensioned and the basin has a depth defined by the distance between the free upper surface and the orifices in such a manner that a predefined minimum average residence time in each of the basins placed under an uppermost and above a lowermost basin of between 8 and 15 seconds, and preferably between 10 and 13 seconds is ensured when the predefined volumetric flow is provided to an uppermost basin.

In an embodiment, the method comprises the further steps that the first, second and third steps are repeated two or more times.

In an embodiment, the first, second and third steps are repeated two or more times with a plurality of basins provided consecutively below each other.

Due to its depth there will in each basin be a residence time for the water, and also the water will be mixed as the water leaving the orifice will plunge into the below basin at a velocity and cause mingling and mixture between well degassed and possibly not so well degassed water from the center of the water column streaming out of the at least one orifice.

The predefined volumetric flow may originate from a fish or other aquatic animal culture that is to be treated. In an embodiment, the distance D may be the same between any adjacent basins. In one embodiment, different distances are provided between different sets of adjacent basins.

By ensuring a predefined minimum residence time at a second, third or more basins below each other, it is ensured that there is time for the carbonic acid to reach an equilibrium state with any remaining dissolved CO₂ after a free fall event, where most dissolved CO₂ has diffused out of the water and into the controlled atmosphere around each column of water exiting an orifice from an above placed basin. This design criterion is possible to reach with just about any volumetric flow of water, and even the size and shape of the orifice may be chosen to predefined measures within certain limits when the volumetric flow of water per orifice has been decided. When CO₂ enters the water, the CO₂ is hydrated quickly and turned to carbonic acid and incorporated in the carbonate-bicarbonate equilibrium. This equilibrium is pH dependent and this implies that only a certain fraction of CO₂ is available to be stripped. Once the available CO₂ is taken out of the water, this missing CO₂ leaves a void in the equilibrium that needs to be filled up. For CO₂ to be hydrated it takes a bit more than one second to happen, as this is a quick reaction, while the reverse, for the carbonate-bicarbonate to go back to carbonic acid and then available CO₂, it takes close to 17 seconds. The above implies that when a traditional trickling filter is used as a CO₂ stripper, it is effective only on the top part thereof as the water will run out of available CO₂.

With the resting times in the water pillows in each basin according to the invention, the chemical properties of water are advantageous, and this allows a further (additional) stripping of CO₂ from the same body of water than what is possible with prior art strippers.

According to the invention, a stream of atmospheric air is provided across the surface of each basin below the uppermost basin. The cross flow of atmospheric air ensures that the CO₂ concentration around the column of water leaving the orifice is well controlled and remains marginally close to the CO₂ concentration of atmospheric air.

In one embodiment, the controlled atmosphere is ambient air (atmospheric air in its natural state).

The circulation of controlled, fresh air around each water column trickling down from an above placed basin also ensures that as much O₂ or oxygen as possible under atmospheric pressure and with the oxygen concentration of atmospheric air is absorbed in the water which has trickled through the gas balancing filter.

It may be advantageous that in a level above the at least one orifice one or more additional (e.g. further set of) orifices are placed, in order to prevent overflow.

It may be an advantage that in a level above the free upper surface of the water, a further set of orifices are placed, in order to ensure against overflow. The further set of orifices may be placed at a bottom part of the basin, which is arranged to rise gradually by being arranged with an angle with respect to the horizontal level. The further set of orifices may be larger and/or provided with less distance between each other, so that this part of the bottom of a basin will let through more water in cases where more water than usual is piped into the gas balancing filter. Prevention of overflow is particularly important with basins lying below an uppermost basin, as they may be enclosed to all sides by sidewalls of the gas balancing filter, and thus a considerable hydrostatic pressure may result if two or more basins below each other are flooded. Such an event could potentially lead to serious damage, especially if the gas balancing filter is constructed from plastic material.

In an embodiment of the invention, water from an aquatic animal culture which is CO₂ rich and depleted from oxygen is supplied to the uppermost basin and by trickling through the consecutively arranged basins below each other, the water is depleted of carbon dioxide, and finally collected in a lowermost basin wherefrom it is pumped back into the aquatic culture. During passage of the gas balancing filter, the water shall also be oxygenated about as far as is possible to reach oxygen equilibrium with the atmosphere. It is customary to have a biological water treatment facility in connection with RAS animal aquatic cultures, and in this case it is preferred that the biological water treatment facility is arranged prior to the gas balancing filter, such that the water exiting the biological treatment facility may enter directly into the gas balancing filter. This has the advantage that any biological process prone to produce CO₂ in the water, such as bacterial consumption of biological remnants from the animal culture, has been completed prior to the entry into the gas balancing filter.

The gas balancing filter according to the invention is a gas balancing filter for degassing CO₂ from a stream of water, wherein the gas balancing filter comprises a top basin arranged to collect a predefined volumetric flow of water to be degassed, wherein the top basin is configured to contain a water column having a free water surface and a depth larger than a predefined level, wherein the top basin comprises one or more orifices arranged below the level of the free surface, wherein the gas balancing filter is configured to discharge water from the top basin out through the one or more orifices and ensure that the water discharged from the top basin out through the one or more orifices will free-fall a distance through a controlled atmosphere, wherein the gas balancing filter comprises one or more lower (arranged below the top basin) basins provided consecutively one below the other and being arranged in such a manner that the predefined volumetric flow of water flows through each provided basin, wherein for each lower basin:
the ratio R between the average horizontal cross-sectional area of the water column in the lower basins and the sum of the areas of the one or more orifices and
the height of the lower basin is selected in such a manner that the following quantity

$$\frac{R H}{\sqrt{2 g H}}$$

is in the range between 8-15 seconds, preferably between 10 and 13 seconds, where g is the acceleration due to gravity and H is the depth of the water column. Hereby, it is possible to provide a gas balancing filter that can provide a more efficient degassing of the water than the prior art gas balancing filters.

In an embodiment, each lower basin which is not a lowermost basin has a bottom plate, which plate has a raised portion, such that this raised portion is only inundated in case of an overflow event. The raised portion means that portion is arranged in a higher vertical position.

It may be an advantage that a fan and a manifold is provided in order to guide a stream of fresh ambient air across the free upper surface of any basin which is not an uppermost basin.

In one embodiment, a supply line carrying CO₂ rich and O₂ depleted water from an aquatic animal culture is arranged at the uppermost basin, and a retrieval line is provided and connected to the lowermost basin to retrieve CO₂ depleted water to be pumped back into the aquatic culture.

It may be beneficial that in the lowermost basin a manifold plate is provided which has a range of water exit openings provided at the intersection of a bottom of the lowermost basin and the manifold plate, whereby the manifold plate is arranged between and fastened to a lowermost basin bottom and an upright outer sidewall of the lowermost basin.

In an embodiment, the ratio R_{T} between the average horizontal cross-sectional area of the water column in the top basin and the sum of the areas of the one or more orifices is in the range 0.5-5%.

In an embodiment, the ratio R_{T} between the average horizontal cross-sectional area of the water column in the top basin and the sum of the areas of the one or more orifices is in the range 1-3%.

In an embodiment, the ratio R_{T} between the average horizontal cross-sectional area of the water column in the top basin and the sum of the areas of the one or more orifices is in the range 1.5-2.0%.

In an embodiment, the ratio R_{T} between the average horizontal cross-sectional area of the water column in the top basin and the sum of the areas of the one or more orifices is in the range 1-1.5%.

It may be advantageous that for each of the lower basins (arranged below the top basin), the ratio R_{L} between the average horizontal cross-sectional area of the water column in the lower basin and the sum of the areas of the one or more orifices is smaller than the ratio R_{T} between the average horizontal cross-sectional area of the water column in the top basin and the sum of the areas of the one or more orifices.

If the basin has vertical side walls, the average horizontal cross-sectional area of the water column corresponds to the area of the bottom plate and the area of the free water surface of the water column.

It may be beneficial that the one or more lower basins are configured to contain a water column having a larger depth than the depth of the water column that the top basin is configured to contain.

In an embodiment, the one or more lower basins are configured to contain a water column having a depth that is at least twice as large as the depth of the water column that the top basin is configured to contain.

In an embodiment, each basin comprises a bottom plate, wherein the bottom plate of the top basin has a smaller area than the bottom plate of the one or more lower basins.

In an embodiment, the number of orifices per square meter in the first plate is 800-1500 in the base plate of the top basin and 600-1400 in the base plate of the lower basins. In one embodiment, the number of orifices per square meter in the first plate is 1000-1400 in the base plate of the top basin and 800-1200 in the base plate of the lower basins. In an embodiment, the number of orifices per square meter in the first plate is 1100-1300 in the base plate of the top basin and 900-1100 in the base plate of the lower basins.

In an embodiment, the area of an average orifice is 10-14 square mm. In an embodiment, the area of an average orifice is 11-13 square mm.

It is typical that for any basin residing below the uppermost basin and above the lowermost basin, the volumetric water flow into the basin, the size and number of orifices and the depth of the basin defined by the distance between the free water surface and the orifices are dimensioned to ensure a minimum average residence time for the water whenever the predefined volumetric flow of water is provided to the uppermost basin. In this way residence time of between 8 and 15 seconds, and preferably between 10 and 13 seconds, may easily be arrived at when a given stream of a predefined volumetric flow from a fish or other aquatic animal culture is to be treated.

In this way a pause or a residence time is provided due to the depth of each basin, whereby it is ensured that the conversion of carbonic acid to dissolved CO₂ may take place, whenever any dissolved CO₂ has been degassed from the water, and thus a more complete degassing is achieved with the gas balancing filter.

In an embodiment, each basin has a bottom plate which has a raised portion such that this raised portion is only inundated in case of an overflow event. Overflows are to be prevented, as basins below the uppermost basin are usually surrounded by wall parts all around and overfilling of a lower basin thus may lead to rising hydrostatic pressure to the extent that it causes rupture of vital parts of the gas balancing filter. The raised bottom part may have larger orifices or orifices which are closer to each other than in any not raised part of the bottom plate such that even a substantial rise in flow may lead to nothing more dramatic than a lowered quality in terms of less degassed output stream from the gas balancing filter. Animal water cultures are usually run with a safety margin such that minor fluctuations in function of any part of the water cleaning facility shall have no consequences.

In an embodiment, the gas balancing filter comprises a fan and a manifold which are arranged in order to guide a stream of fresh ambient air across the free upper surface of any basin which is not an uppermost basin. The fresh ambient air will then pass perpendicular to the water column or water columns from the at least one orifice provided in each basin which is not the lowermost basin. In this way it is ensured that the atmosphere around any water free-falling from beneath an orifice is well controlled.

In an embodiment, a supply line carrying carbon dioxide rich and oxygen depleted water from an aquatic animal culture is arranged at the uppermost basin, and a retrieval line is provided and connected to the lowermost basin to retrieve carbon dioxide depleted and oxygenated water to be pumped back into the aquatic culture. In this way the aquatic animal culture such as fish, crustaceans and shell-fish culture may be sustained with a high degree of recirculated water for the benefit of the environment.

In an embodiment, a manifold plate is provided in the lowermost basin which manifold has a range of water exit openings provided at the intersection of a bottom of the lowermost basin and the manifold plate, whereby the manifold plate is arranged between a lowermost basin bottom and an upright outer sidewall of the lowermost basin. The manifold plate ensures that water may be extracted from the lowermost basin evenly along the length thereof, such that no pockets of still-standing water are allowed. It is to be understood that the manifold plate also adds strength to the sidewalls of the lowermost basin, and in consideration of the fact that the basins above the lowermost basin rest their entire weight on these same sidewalls, this strengthening factor is important.

The entire gas balancing filter may be constructed in any suitable material including stainless steel or a polymer material such as polypropylene (PP), polyoxymethylene (POM). Accordingly, the gas balancing filter will not be prone to corrosion even when used to degas water from marine cultures with a high salinity. Polymer materials such as PP or POM offer advantages, such as smooth surfaces on which bacteria do not easily adhere and thus problems of bacterial growth on internal surfaces are diminished.

In an embodiment of the invention, the orifices provided in the bottom of the basins have a diameter of between 2 mm and 5 mm, and preferably 4 mm. If a given measure such as 4 mm is chosen, the realized diameters for each hole or orifice may deviate slightly therefrom due to production variations. It is preferred that all orifices are circular and arranged perpendicular to the plane surface of the bottom plate of the basins. The bottom plate is usually made as thin as possible but shall also be able to sustain the weight of the water pillow residing in each basin. If plastic material is used to construct the gas balancing filter, a somewhat thicker bottom plate is anticipated. The space between the holes shall be between 2 and 5 times the hole diameter on average. This space leaves plenty of room for the circulation of fresh air between the downpouring water columns provided at the underside of each basin apart from a lowermost basin, while it allows for enough material in the bottom plate to sustain the weight of the water pillow above.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 shows a schematic side view of a gas balancing filter 2 according to the invention with an aquatic animal culture 20 and water exchange lines displayed;

FIG. 2 shows an enlarged cross-sectional view of a gas balancing filter 2 according to the invention;

FIG. 3 shows an enlarged part of FIG. 2;

FIG. 4 shows a line drawing of the section in FIG. 3, but without displaying water and arrows;

FIG. 5 is a sectional view of the gas balancing filter displaying also a biological treatment facility 32 inserted in front of the gas balancing filter 2;

FIG. 6 shows a sectional view in 3D display with a section plane along line AA shown in FIG. 5;

FIG. 7 is an enlarged sectional view in 3D of a basin (6.2; 6.3) without water;

FIG. 8 discloses a section through an end part of a basin;

FIG. 9 is an enlarged plan view of a part of a bottom plate; and

FIG. 10 shows a schematic cross-sectional view of a top basin and a second basin of a gas balancing filter according to the invention.

### DETAILED DESCRIPTION

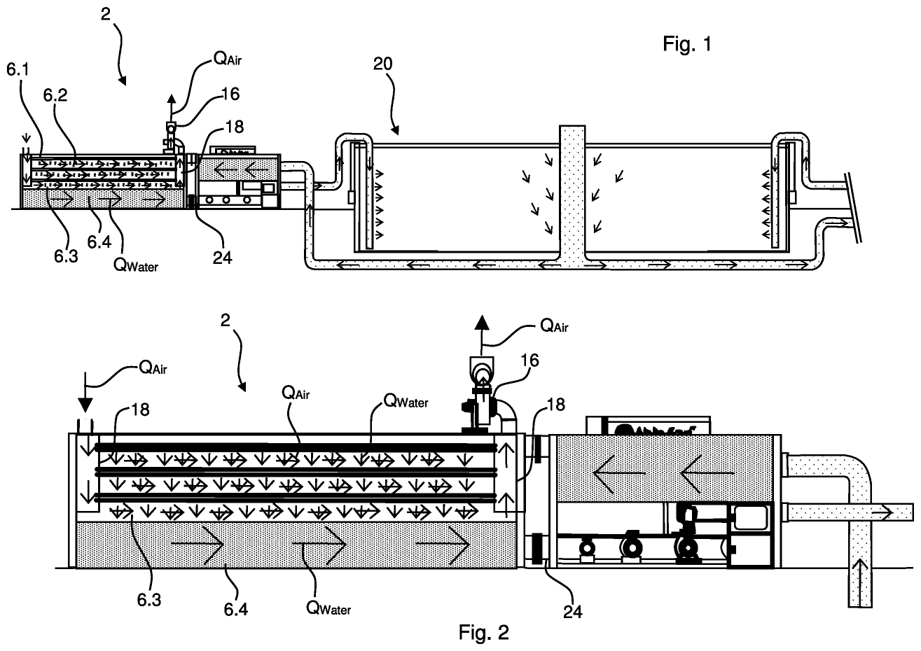

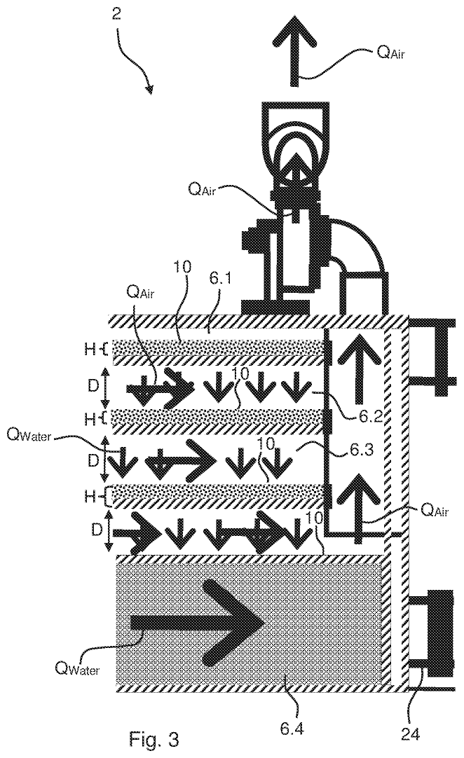

Referring now in detail to the drawings for the purpose of illustrating embodiments of the present invention, a gas balancing filter 2 of the present invention is illustrated in FIG. 1, in FIG. 2 and in FIG. 3. When in use, the water is collected, in a first step, in an uppermost basin 6.1 with a free upper surface 10 and a depth H. The depth is indicated in FIG. 3, which shows an enlarged cross-sectional view of a gas balancing filter 2 according to the invention. In a second step, the water is allowed to flow out of the basin 6.1 through at least one orifice 8. The at least one orifice 8 is provided beneath the free upper surface 10, and in a third step, the water which flows out of the orifice 8 is allowed to free-fall a distance D through a controlled atmosphere and is then collected in a further basin 6.2 provided beneath the uppermost basin 6.1. This method is improved according to the invention in that the first, second and third steps are repeated two or more times with basins 6.2, 6.3 provided consecutively below the first basin 6.1 and below each other. When the water is allowed to free-fall the distance D after trickling out of the at least one orifice, the CO₂ locked in the water may diffuse to the surface of the column of water trickling downward under the influence of gravity towards the surface of an underlying basin. The temporarily enlarged surface of the water which may be accomplished by having a large number of rather small holes or orifices per square unit bottom surface of the basin 6.1, 6.2, 6.3 may ensure that virtually all CO₂ trapped as dissolved CO₂ in the water shall reach the surface and become dissolved in the controlled atmosphere around each column of water. In each basin 6.2, 6.3 below the uppermost basin 6.1, the water will be thoroughly mixed and any part of the water forming an innermost layer in a column of water entering the basin, may exit the basin in an outermost layer. Thus, the simple repetition of trickling through an orifice in the bottom of a basin and collection of water below this basin in yet another basin and repeating this series of actions from the second basin, will enhance CO₂ stripping from the water.

FIG. 3 shows an enlarged cross-sectional view of a gas balancing filter 2 according to the invention, and here a fan 16, and arrows marked Q_{Air} in FIG. 3 show how the fan draws fresh air across each surface of the basins 6.2, 6.3, 6.4. A lowermost basin 6.4 shall have no orifices at its bottom, as water collected in this basin 6.4 shall be almost completely freed of CO₂ and also be almost as oxygenated as possible for water when it has reached an oxygen saturation of close to 100%. Arrows marked Q_{Water} are also seen in FIG. 3, and they indicate a flow of water. Thus, it can be observed that water and air pass perpendicular to each other below each basin.

In FIG. 2, an inlet manifold is shown to the left and an outlet manifold is shown below the fan 16 to the right of the basins 6. The manifolds are connected to the areas above basins 6.2, 6.3 and 6.4 by way of suitable holes (not indicated in the drawings). Thereby downwardly trickling water from basins 6.1, 6.2, 6.3 shall experience an air flow of fresh ambient air around each column of water, which ensures that air with a content of CO₂ and O₂ close to CO₂ and O₂ concentrations of atmospheric air is provided continually, such that a controlled composition of the atmosphere around the downwardly trickling water is ensured.

When a predefined volumetric flow of the water is arranged along with orifices 8 which are outlined with regard to number per area bottom surface and dimensioned with respect to diameters and further the basin has a depth defined by the distance between the free upper surface 10 and the orifices 8, it may be achieved that a predefined minimum average residence time is provided for the water in each of the basins 6.2, 6.3 placed under an uppermost basin 6.1 and above a lowermost basin 6.4. The predefined volumetric flow is provided to an uppermost basin 6.1, and preferably the uppermost basin 6.1 is dimensioned with regard to vertical extent and orifice number and size in much the same way as underlying basins 6.2, 6.3 (apart from a lowermost basin, which shall not allow the water to trickle out into a controlled atmosphere, and thus has a differently shaped exit) even if a residence time is not required in the uppermost basin.

The residence time in basins 6.2, 6.3 below the uppermost basin 6.1 is important as CO₂ in the water resides partially as dissolved CO₂ and partially as carbonic acid, the two forming an equilibrium in the water. CO₂ cannot exit the water and enter the atmosphere around or above the water unless it is dissolved as CO₂ in the water. Thus, even if the water quickly loses its dissolved CO₂, carbonic acid remains within the water, but once the CO₂ is out of the water, a new equilibrium state may form, in which a portion of the remaining carbonic acid is converted to CO₂. However, this process is time-consuming and thus the residence time in each of the basins 6.2, 6.3 below the uppermost basin 6.1 and above the lowermost basin 6.4 helps in allowing more CO₂ to leave the water and enter the controlled atmosphere. The construction of the gas balancing filter 2 with at least two layers of trickle-down orifices and a residence time before each trickle-down event is instrumental in ensuring that the resulting water is well free of CO₂.

It is to be understood that in order to reach a given residence time, when a predefined volumetric flow of water is given, and a preferred diameter of the at least one orifice is given, it is required to calculate the number of orifices per square measure of basin bottom. The orifice diameter is determined by the available space or distance D between the underside of a basin and the free upper surface 10 of the water in a below arranged basin, as the larger holes or orifices shall give a larger diameter of the water column below the orifice, and thus a longer time is demanded for the CO₂ to exit the water and enter the controlled atmosphere.

It is also to be understood that the system of basins stacked above each other which is provided according to the invention also allows for some self-regulating mechanisms regarding water flow. In case the pumping action increases to the volumetric water flow, this will cause rising level or depth between the free surface and the bottom of the basins. Accordingly, this will cause a higher flow rate out of the orifices at the bottom due to increased hydrostatic pressure. If the pumping action is reduced, the depth of the basins and thus the flow rate out of the basins will be decreased. In both cases a residence time in each basin shall not be affected to any significant extent, and thus the process in the gas balancing filter is not very dependent on a constant flow of water through the system. However, the system shall be designed to deal with a predefined volumetric flow of water, at which flow an optimized performance is obtained.

It may happen during use that orifices are blocked such as by growth of bacteria or microorganisms or by deposit of solid particles in the water, and in this case an overflow may be the result with water flowing out of the gas balancing filter or causing the gas balancing filter to sustain damage or even break down. To avoid this, any basin above the lowermost basin 6.4 and below the uppermost basin 6.1 comprises a section of orifices which are provided in a raised bottom portion. These orifices may be significantly larger than the usual orifices and/or placed at a reduced distance from each other. Thus, if the usual orifices become blocked or an excessive pumping action becomes necessary, water may rise in each basin such that the raised bottom portions become inundated and water shall be allowed to at least trickle down to a below arranged basin through the further orifices of the raised bottom portions. This may be to the detriment of the performance of the gas balancing filter, however, it may nonetheless ensure its survival as a functioning part of a husbandry with fish or other animals living submerged in the water.

In FIG. 5, a sectional view of the gas balancing filter displaying also a biological treatment facility 32, inserted upstream of the gas balancing filter 2, is disclosed, such that water from an aquatic animal culture 20 which is carbon dioxide rich and depleted from oxygen may be supplied initially to the biological treatment facility 32, and after undergoing treatment here, may be supplied to the uppermost basin through a supply line 22 and by trickling through the consecutively arranged basins 6.1, 6.2, 6.3 below each other, the water is depleted of carbon dioxide and also oxygenated, to be finally collected in a lowermost basin 6.4 wherefrom it is pumped back into the aquatic culture 20. The initial treatment in the biological treatment facility is instrumental in ensuring that there are no traces of biologically decomposable particles in the water, which might otherwise cause renewed release of CO₂ during the treatment in the gas balancing filter.

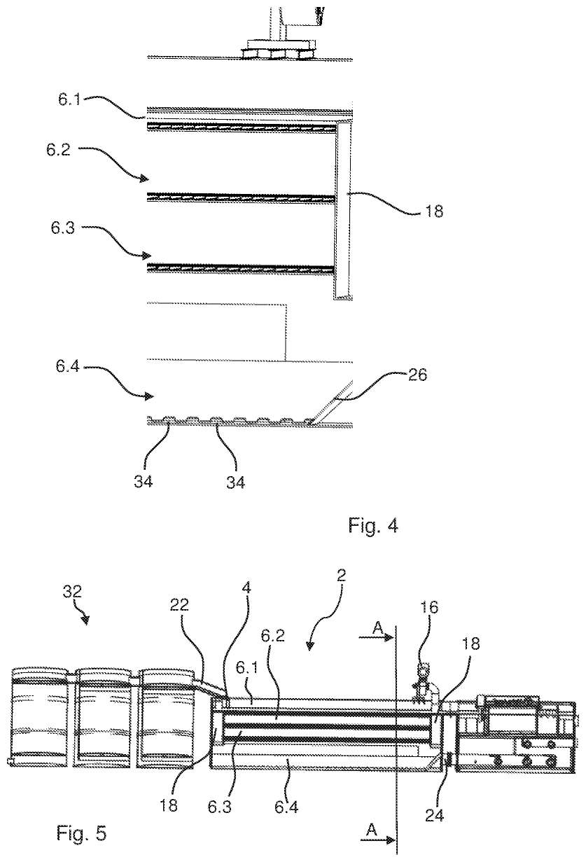

FIG. 4 shows a line drawing of the section in FIG. 3, but without displaying water and arrows, and thus the manifold plate 26 is visible. The plate forms a range of openings 34 along the bottom 28 of the lowermost basin, and water exits the lowermost basin 6.4 through these holes. A retrieval line 24 is coupled to the lowermost basin 6.4 as seen in FIGS. 3 and 5 and water in the triangular space between the lowermost basin bottom 28, the manifold plate 26 and the upright outer sidewall 30 of the lowermost basin shall exit through the retrieval line 24 to be pumped onward to the water tanks for care of the animals such as fish or crustaceans. The range of openings 34 shall ensure that water is withdrawn from the lowermost basin 6.4 at an even rate along an entire length thereof, so that no pockets of still-standing water are formed. At the same time the manifold plate ensures an enhanced resilience to the sidewall 30 of the gas balancing filter 2.

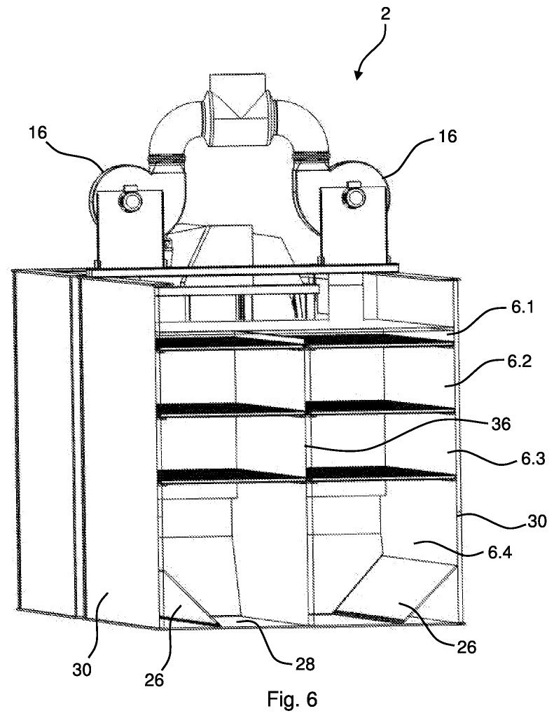

FIG. 6 shows a sectional view in 3D display with a section plane along line AA shown in FIG. 5, and here it is seen that each basin is sectioned by a partition wall 36 which extends continuously along the entire length of the gas balancing filter 2. In principle, the gas balancing filter 2 could be sectioned into as many individual parts as there are holes or orifices in the bottom of every basin, but for practical reasons it is desired to keep each basin with an unbroken surface. However, as the present gas balancing filter is constructed of polymer material, the possible extent of each basin shall be limited. Even if the wall 36 is thus also a constructional and strengthening measure, it allows gas balancing filters at each side of the wall 36 to be operated independently of each other, in case this is desired, and in an upstart phase, where fish are gradually added to fish tanks this option may be beneficial.

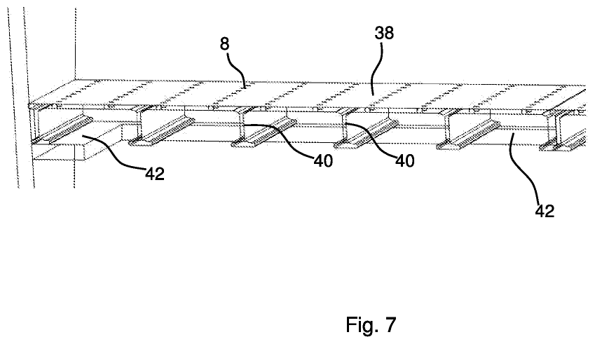

FIG. 7 is an enlarged sectional view in 3D of a basin 6.2; 6.3 without water. Here the individual holes or orifices in the bottom plate of a basin 6.2; 6.3 are visible. As also seen the bottom plate 38 comprises sections of profiles with integrated support beams 40. The orifices are provided in rows between the support beams. Each bottom plate 38 is resting on a rail 42 in order to transfer the weight of the water pillow, which will reside thereon during operation, into the sidewalls 30, 36 of the gas balancing filter 2 or stripper.

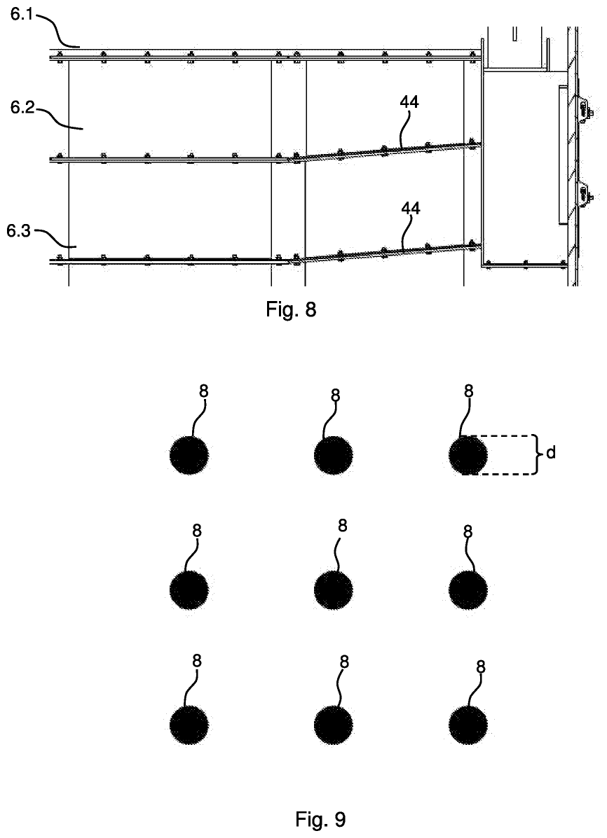

In FIG. 8 it is disclosed how an end part 44 of a basin 6.2, 6,3 has a bottom which is angled upward with respect to a horizontal direction. Under normal conditions, water will only submerge a small part of this end part 44, but if at some point increased water flow is induced into this basin, the end part 44 shall become increasingly inundated and due to the orifices therein, increased flow out of the basin will be the result. Possibly orifices are larger or placed with a higher density on this plate section in order to avoid overflow of the basin.

In FIG. 9 an enlarged plan view of a small part of a bottom of a basin 6.1, 6.2, 6.3 is disclosed. The orifices 8 are shown as black dots, and as seen they all have the same diameter. In this case the diameter is nominally 4 mm.

In an embodiment of the gas balancing filter, the gas balancing filter has a length of about 10 meters, a height of around 3 meters. The average residence time is around 10-13 seconds at normal volumetric flow rate.

In the disclosed embodiment the orifices are round, but oval, star-shaped or slit formed orifices may be used or combinations thereof.

A bottom surface according to the embodiment disclosed in FIG. 9 may comprise orifices of 4 mm in diameter. A first plate may be defined which has around 1000 holes per m² of plate surface. With these measures, it will be possible at a desired flow rate to dimension the size of the basins 6.2 and 6.3, residing between an uppermost basin 6.1 and a lowermost basin 6.4, such that a depth of 105 mm is provided when using the first plate. In these basins the vertical measure from the free upper surface 10 of the water to the orifices 8 at the bottom of the basins shall then nominally be 105 mm. Dimensioned like this, the average residence time for the water shall be between 10 and 13 seconds. In actual use, the depth may vary slightly due to slightly varying pumping action or other particulars, such as impurities in the water or possible deposits in and around the orifices 8, however, as already explained this will not impede the overall function of the gas balancing filter.

A bottom of the uppermost basin may be dimensioned using a second plate, which has slightly above 1200 holes per m² (same diameter of the orifices at nominally 4 mm as above) and this may result in a slightly lower depth of around 70 mm given the same predefined volumetric flow and size of an uppermost basin 6.1 as for the above two consecutively arranged basins 6.2 and 6.3. As mentioned, the uppermost basin 6.1 need not provide a residence time, as no new equilibrium is desired for the water flowing onto this basin.

The raised portions of bottom plate 44 shown in FIG. 8 may benefit from the increased number of holes in the second plate, and thus this particular plate is used for the raised portions disclosed in FIG. 8.

When a depth of basins 6.2 and 6.3 and 6.4 (not being an uppermost basin 6.1) has been defined, also the free fall distance D shall be defined, as the distances between the basins is given by the constructional measures of the gas balancing filter. In the embodiment disclosed in FIG. 3, the free fall distance is around 490 mm. As the water columns fall this distance, the CO₂ shall leave the water and enter the surrounding air, which due to the action of the fan 16 is replenished constantly and will remain controlled with a CO₂ percentage which is only very slightly increased in comparison to the CO₂ percentage of ambient air.

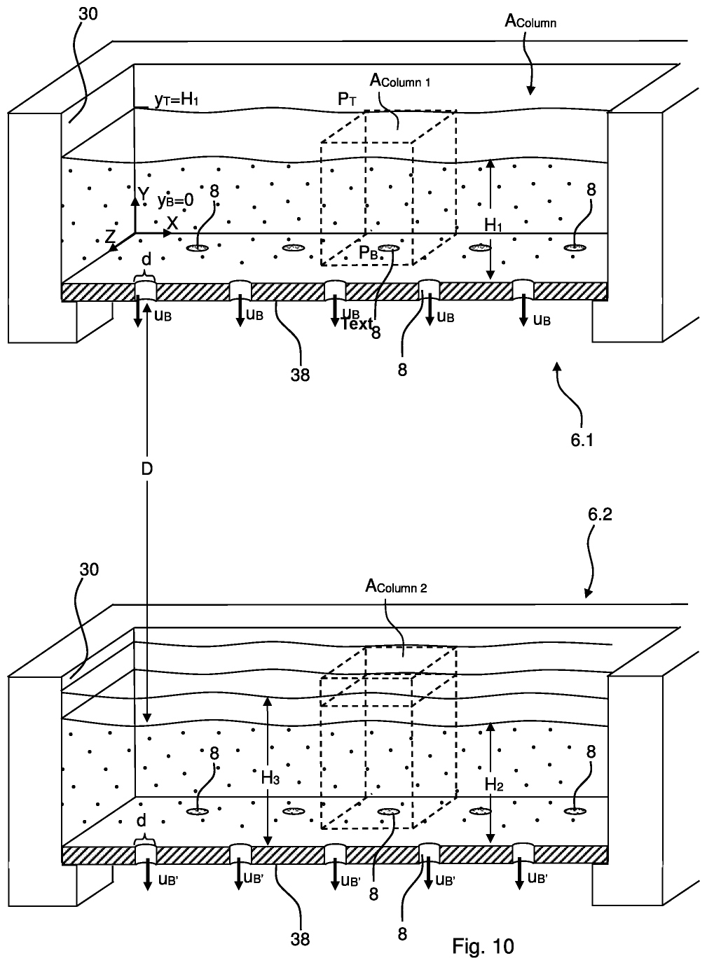

FIG. 10 illustrates a schematic cross-sectional view of a top basin 6.1 and a second basin (6.2) of a gas balancing filter according to the invention. The second basin (6.2) is arranged below the top basin 6.1. Each basin 6.1, 6.2 comprises a bottom plate 38 provided with a plurality of circular orifices 8. Each basin 6.1, 6.2 furthermore comprises upright outer sidewalls 30. The sidewalls 30 and the bottom plate 38 constitute a basin portion configured to receive and contain a predefined volumetric flow of water to be degassed.

In an embodiment, the predefined volumetric flow of water is 25-200 L. In an embodiment, the predefined volumetric flow of water is 50-100 L. In an embodiment, the predefined volumetric flow of water is 65-85 L.

The top basin 6.1 is configured to contain a water column having a free water surface and a depth H₁ larger than a predefined level (e.g. the height of the basin 6.1 (measured from the bottom plate 38). The orifices 8 of the top basin 6.1 are arranged below the level of the free surface of the water. The gas balancing filter is configured to discharge water from the top basin 6.1 out through orifices 8 and ensure that the water discharged from the top basin 6.1 out through the one or more orifices 8 will free-fall a distance D through a controlled atmosphere.

FIG. 10 indicates the velocity u₁ of the water being discharged from the through orifices 8 in the bottom plate 38 of the top basin 6.1 as well as the velocity u₂ of the water being discharged from the through orifices 8 in the bottom plate 38 of the second basin 6.2.

A water column is indicated above an orifice 8 in both the top basin 6.1 and the second basin 6.2. The horizontal cross-sectional areas A_{Column 1}, A_{Column 2} of each are indicated.

The pressure P_{T} at the water surface of the top basin 6.1 is indicated. Likewise, the pressure P_{B} at the water surface of the top basin 6.1 is indicated. A Cartesian coordinate system with a vertical axis Z, and two horizontal axes X, Z of the top basin 6.1 is indicated.

When considering a first point at the bottom and a second point at the top surface of the water column in the top basin 6.1, we can use Bernoulli's Equation that reads:

P+½ρu²+μgy=constant (1)

where P is the pressure, ρ is the density of water, u is the speed, g is acceleration due to gravity and y is the vertical position.

When inserting the values for a point at the bottom and a point at the top surface of the water in one of the basins one finds that:

P_{T}+ρgy_{T}+½ρu_{T}²=P_{B}+ρgy_{B}+½ρy_{B}² (2)

where P_{T} is the pressure at the top of the water column in the basin. y_{T} is the vertical position of the top of the water column in the basin, u_{T} is the speed of the water at the top portion of the basin, P_{B} is the pressure at the outlet of the orifice 8, y_{B} is the vertical position of the orifice 8, u_{B} is the speed of the water leaving the orifice 8. For simplicity we assume that the horizontally velocity of the water can be neglected.

We assume that y_{B}=0 and u_{T}=0 and Y_{T}=H. Moreover, we expect that P_{T}=P_{B}=0 (defining the ambient pressure as zero) since the atmospheric pressure is present both at the top surface of the water column and at the points at which the water leaves the orifices 8. Accordingly, one can derive that:

ρgH=½ρu_{B}² (3)

Now it follows that

u_{B}=\sqrt{2gH} (4)

This means that the speed of the water leaving an orifice 8 depends only on the depth H of the water column. The Qᵢ flow through an orifice 8 having an area A_{O(i)} is given by:

Qᵢ=A_{O(i)}u_{B(i)} (5)

where u_{B(i)} is the speed of the water being discharged through the orifice 8 having an area A_{O(i)}. When applying a horizontally arranged bottom plate 38 with N orifices 8 of equal area A_{O(i)}=A_{O}, the speed u_{B} of the water being discharged through the orifices is the same. Accordingly, one can deduce that:

Q=Σᵢ₌₁^{N}A_{O(i)}u_{B(i)}=NA_{O}u_{B}=NA_{O}\sqrt{2gH} (6)

The average residence time T of water in the basin having an area A_{basin} and a water column depth H is given by:

$$T = \frac{{A}_{basin} H}{Q} = \frac{{A}_{basin} H}{{NA}_{O} \sqrt{2 g H}} = \frac{R H}{\sqrt{2 g H}} \qquad ( 7 )$$

where R is the ratio between the total area of the orifices 8 and the area of the bottom plate 38 of the basin.

The second basin 6.2 is designed in such a manner that

$$\frac{R H}{\sqrt{2 g H}}$$

is in the range between 8-15 seconds, preferably between 10 and 13 seconds.

By a residence time in this range, there is sufficient time for the carbonic acid to reach an equilibrium state with any remaining dissolved CO₂ after a free fall event. The majority of dissolved CO₂ having been diffused out of the water and into the controlled atmosphere.

The velocity u_{B} of water that leaves the orifices 8 from the bottom plate 38 of the top basin 6.1 is indicated. Likewise, the velocity u_{B′} of water that leaves the orifices 8 from the bottom plate 38 of the second basin 6.2 is indicated.

If the flow through the orifices 8 of the bottom plate 38 of the top basin 6.1 is larger than the flow through the orifices 8 of the bottom plate 38 of the second basin 6.2, the depth H₂ will increase to a greater depth H₃ as indicated in basin 6.2. Consequently, when the water level raises in a basin 6.1, 6.2, the flow through the flow through the orifices 8 of the bottom plate 38 will increase in accordance with equation (6):

Q=Σᵢ₌₁^{N}A_{O(i)}=NA_{O}u_{B}=NA_{O}\sqrt{2gH} (6)

Accordingly, instead of extending the processing time according to the flow increment, the gas balancing filter is configured to automatically increase the flow out of a basin if the flow into the basin is increased.

### LIST OF REFERENCE NUMERALS

2 Gas balancing filter
4 Stream of water
6.1 Uppermost basin
6.2 Second basin
6.3 Third basin
6.4 Lowermost basin
8 Orifice
10 Free upper surface
14 Raised bottom part
16 Fan
18 Manifold
20 Aquatic animal culture
22 Supply line
24 Retrieval line
26 Manifold plate
28 Lowermost basin bottom
30 Upright outer sidewall
32 Biological water treatment facility
34 Range of openings
36 Partition wall
38 Bottom plate
40 Integrated support beams
42 Rail
44 Raised portion of bottom plate
D Free fall distance
Q_{Air} Air flow
Q_{Water} Water flow
Q, Qᵢ Flow
d Diameter of orifices
H, H₁, H₂, H₃ Depth
P, P_{T}, P_{B} Pressure
A_{Column 1}, A_{Column 2} Area
A_{O}, A_{O(i)} Orifice area
X, Y, Z Axis
P, P_{B}, P_{T} Pressure
ρ Density
u, uᵢ, u_{T}, u_{B}, u_{B′} Velocity
g Acceleration due to gravity
y, y_{B}, Y_{T} Vertical position
T Residence time
N Number of orifices
R, R_{L}, R_{T} Ratio between the total area of the orifices and the area of the bottom plate
A_{basin} Area of basin

What is claimed is:

1. A method for degassing carbon dioxide from a stream of water, whereby water with a predefined volumetric flow is supplied to a gas balancing filter, wherein the water in a first step is collected in a basin with a free upper surface and a depth (H) and in a second step is allowed to flow out of the basin through at least one orifice provided beneath the free upper surface and in a third step, the water flowing out of the at least one orifice is allowed to free-fall a distance (D) through a controlled atmosphere and is then collected in a further basin provided beneath the basin, wherein
the predefined volumetric flow of the water is selected;
the at least one orifice is dimensioned; and
the depth (H) of the basin is defined by the distance between the free upper surface and the at least one orifice such that a predefined minimum average residence time for the water in the basin is between 8 and 15 seconds.

2. The method according to claim 1, wherein the first, second and third steps are repeated two or more times.

3. The method according to claim 2, wherein the first, second and third steps are repeated two or more times by using a plurality of basins provided consecutively below each other.

4. The method according to claim 1, further comprising providing a stream of air across the free upper surface of the basin.

5. The method according to claim 1, further comprising providing one or more additional orifices at a level above the at least one orifice to ensure against overflow.

6. The method according to claim 1, wherein the water supplied to the gas balancing filter is water from an aquatic animal culture which is CO₂ rich and depleted of O₂.

7. The method of claim 6, further comprising pumping water from the further basin back into the aquatic animal culture.

8. A gas balancing filter for degassing CO₂ from a stream of water, wherein the gas balancing filter comprises a top basin arranged to collect a predefined volumetric flow of water to be degassed, wherein the top basin is configured to contain a water column having a free water surface and a depth (H) larger than a predefined level, wherein the top basin comprises one or more orifices arranged below the level of the free water surface, wherein the gas balancing filter is configured to discharge water from the top basin out through the one or more orifices and ensure that the water discharged from the top basin out through the one or more orifices will free-fall a distance (D) through a controlled atmosphere, wherein the gas balancing filter comprises a lower basin provided below the top basin and arranged such that the predefined volumetric flow of water flows through one or more orifices within the lower basin, wherein for the lower basin:
a ratio (R_{L}) between an average horizontal cross-sectional area (A_{column}) of a water column in the lower basin and a sum of areas (A_{O}) of the one or more orifices below the water column in the lower basin; and
a height of the lower basin is selected such that
$$\frac{{R}_{L} H}{\sqrt{2 g H}}$$
is in a range between 8-15 seconds, where g is acceleration due to gravity.

9. The gas balancing filter according to claim 8, wherein the lower basin has a bottom plate with a raised portion that is only inundated in case of an overflow event.

10. The gas balancing filter according to claim 8, further comprising a lowermost basin.

11. The gas balancing filter according to claim 10, wherein a fan and a manifold provide a stream of air across a free upper surface of the lowermost basin.

12. The gas balancing filter according to claim 8, wherein a fan and a manifold provide a stream of air across a free upper surface of the lower basin.

13. The gas balancing filter according to claim 8, wherein a supply line carrying CO₂ rich and O₂ depleted water from an aquatic animal culture is arranged at the top basin, and a retrieval line is connected to a lowermost basin to retrieve CO₂ depleted water to be pumped back into the aquatic animal culture.

14. The gas balancing filter according to claim 8, wherein, in a lowermost basin, a manifold plate is provided that has a range of water exit openings provided at the intersection of a bottom of the lowermost basin and the manifold plate.

15. The gas balancing filter according to claim 14, wherein the manifold plate is arranged between and fastened to the bottom of the lowermost basin and an upright outer sidewall of the lowermost basin.

16. The gas balancing filter according to claim 8, wherein a ratio (R_{T}) between an average horizontal cross-sectional area (A_{column}) of the water column in the top basin and a sum of areas (A_{O}) of the one or more orifices below the water column in the top basin is in a range of 0.5-5%.

17. The gas balancing filter according to claim 16, wherein the ratio (R_{L}) is smaller than the ratio (R_{T}).

18. The gas balancing filter according to claim 8, wherein the lower basin is configured to contain a water column having a larger depth (H) than a depth of the water column that the top basin is configured to contain.

19. The gas balancing filter according to claim 8, wherein a bottom plate of the top basin has a smaller area than a bottom plate of the lower basin.

20. A method for degassing carbon dioxide from a stream of water, comprising:
arranging a top basin to collect a predefined volumetric flow of water to be degassed, the top basin configured to contain a water column having a free water surface and a depth (H) larger than a predefined level, wherein the top basin comprises one or more orifices arranged below the level of the free water surface;
discharging water from the top basin out through the one or more orifices and ensuring that the water discharged from the top basin out through the one or more orifices will free-fall a distance (D) through a controlled atmosphere; and
providing a lower basin below the top basin and arranged such that the predefined volumetric flow of water flows through one or more orifices within the lower basin, wherein for the lower basin:
a ratio (R_{L}) between an average horizontal cross-sectional area (A_{column}) of a water column in the lower basin and a sum of areas (A_{O}) of the one or more orifices below the water column in the lower basin; and
a height of the lower basin is selected such that
$$\frac{{R}_{L} H}{\sqrt{2 g H}}$$
is in a range between 8-15 seconds, where g is acceleration due to gravity.
